(19) United States
(12) Patent Application Publication
(10) Pub. No.: US 2006/0251248 A1
(43) Pub. Date: Nov. 9, 2006

(54) Public key cryptographic methods and systems with preprocessing

(76) Inventor: Jesse Lipson, Raleigh, NC (US)

Correspondence Address: Jesse Lipson, 2701-106 Glenwood Gardens Lane, Raleigh, NC, 27603, US

(21) Appl. No.: 11/416,917

(22) Filed: May 3, 2006

Related U.S. Application Data
(60) Provisional application No. 60/677,190, filed on May 3, 2005.

(51) Int. Cl. H04L 9/00

(52) U.S. Cl. 380/44

(57) ABSTRACT

A system and method for public key cryptosystem for secure communication of messages including at least one message encrypted by standard RSA methods; and a predetermined number of prime factors used for the generation key(s) for decryption including a modulus N and an exponent e, wherein a proper subset of the prime factors of the modulus N, along with the exponent e, are required to decrypt messages encrypted using the public exponent e and the public modulus N, N is generated using RSA methods, and encryption occurs using RSA methods, wherein the exponents d and e are generated such that e*d=1 mod (N−1) and gcd(e,d)=1, and further including additional method steps for preprocessing plaintext messages to prevent potential security attacks within the context of superset RSA; and wherein the system is operable to decrypt encrypted messages using the key(s).

### CROSS-REFERENCE TO RELATED APPLICATIONS

This non-provisional utility patent application claims the benefit of prior filed provisional application Ser. No. 60/677,190 filed May 3, 2005.

### BACKGROUND OF THE INVENTION

(1) Field of the Invention

The present invention relates generally to cryptography and, more particularly, to public key cryptographic systems such as RSA.

(2) Description of the Prior Art

With the enormous volume of data that is transmitted electronically throughout the world, methods for securing the privacy of that data are crucial to the economy. Before the 1970s, senders and recipients would need to agree on some sort of secret key in order to encrypt messages such that they could not be deciphered by unauthorized third parties but could still be read by the intended recipient. This sort of symmetric cryptography alone is inconvenient in the Internet age, where it is not always easy to arrange a meeting to exchange a secret password that will allow for future secure communications. Fortunately, public key cryptography was developed in the last few decades by Diffie, Hellman, Rivest, Shamir, and Adelman, among others.

Public key cryptography allows for the secure exchange of information between senders and recipients without the necessity that the two parties first exchange a secret key. The recipient simply makes his public key available, which can be used by anyone to encrypt a message to him. Once a message is encrypted using the recipient's public key, only the private key can be used to restore the message to its original state. Only the recipient knows his private key, so messages encrypted with the public key are secure.

The standard methods for public key cryptography were developed by Rivest, Shamir, and Adelman (RSA), described in U.S. Pat. No. 4,405,829. RSA and its variants provide for encryption of data using a public key and decryption using a private key.

RSA security has been publicly and commercially used for communicating or transmitting information, data, documents, messages, and files; however, it is relatively slow (especially the process of decryption) and computationally intensive. This presents problems in many implementations, including servers that receive a large number of requests and mobile devices that have a small amount of computing resources available to them. The slow speed of RSA is a result of the large numbers required to ensure the security of the algorithm. The RSA scheme capitalizes on the extreme difficulty of factoring a large composite number into its constituent primes.

RSA and CRT RSA

RSA consists of three steps: key generation, encryption, and decryption.

Key Generation

Key generation starts by deciding on an adequate length for what is called the public modulus N. This choice is dictated by the difficulty of factoring N into its prime factors. Right now, N of length 1024 bits is considered a sufficient size to prevent factoring. The bit length of N will continue to go up in the future. Next, two random prime numbers that are each half the length of N, p and q, are generated. Next, a small odd integer, e, is selected such that e is relatively prime to lcm(p−1, q−1). In practice, e is usually chosen to be 65537. In this paper, we will refer to e as the public exponent and N as the public modulus. The RSA public key consists of the two integers (e, N).

The private exponent, d, is a multiplicative inverse of e(mod lcm(p−1, q−1)), so that e*d=1 mod (lcm(p−1, q−1)). Often, the private key refers to the set of numbers (p,q,d), so d should be referred to as the private exponent rather than as the private key.

Encryption

To encrypt message X using an RSA public key {e, N}, one must first convert X into an integer M using a formatting operation. Encryption of M into ciphertext C is then accomplished by calculating C as the remainder after N is divided into M taken to the power of e. In equation form, C=Memod N where M is an integer greater than −1 and less than N, 0≦M<N.

Decryption

To decrypt using the original implementation of RSA, M is obtained by calculating the remainder after N is divided into C taken to the power of d. In equation form, M=C^{d} mod N. M is then converted back to X by reversing the same formatting operation that was used to obtain M from X originally.

It is standard practice now to use the Chinese Remainder Theorem (CRT) for RSA decryption. Rather than compute M=C^{d} mod N, one calculates dₚ=d mod (p−1) and d_{q}=d mod (q−1). Then, one calculates Mₚ=C^{d}^{ₚ} mod p and M_{q}=C^{d}^{_{q}} mod q. Then, one uses CRT to calculate M from Mₚ and M_{q}. This is about four times as fast as calculating M=C^{d} mod N directly. For the remainder of this paper, we will refer to this method of RSA decryption as CRT RSA.

Since CRT RSA, a handful of improvements to the RSA methodology have been made to increase decryption speed. We will touch on each of these methods briefly, with more attention paid to Multi-Prime and Multi-Power RSA, which are more in the field of the present invention.

Multi-Prime RSA

This method is detailed in U.S. Pat. No. 5,848,159. Multi-Prime RSA suggests the use of more than two distinct prime factors to generate the public modulus N, whereas the RSA method traditionally uses only two distinct prime factors. For a modulus N of length 1024 bits, Multi-Prime RSA chooses three prime numbers p, q, r that are each one third the length of N. The encryption process is exactly the same as traditional RSA. The decryption process for Multi-Prime RSA is relevantly similar to that of CRT RSA, except that three or more distinct prime numbers are used instead of two. In Multi-Prime RSA, like in traditional and CRT RSA, all of the distinct prime factors of the modulus N are used for decryption of messages.

Using multiple prime factors for RSA decryption increases the total number of calculations that need to be performed, but each calculation is less intensive since each prime factor is smaller than in the two-prime implementation. The result is a theoretical speedup of b²/4, where b is the number of prime factors used. With N of length 1024 bits and b set to 3 (the current maximum for security reasons), Multi-Prime RSA achieves a theoretical speedup of 2.25 over two-factor CRT RSA methods.

Multi-Power RSA

This method is detailed in United States Patent Application 20020064278. This method is similar to the Multi-Prime method, except that the Multi-Prime method assumes that all of the prime numbers that make up the composite number N are distinct numbers. The Multi-Power method assumes that N is made up of more than two prime factors, but that N is only made up of exactly two distinct prime factors. So, if N=p*q*r, it is assumed that p=q and therefore N=p²r. Like Multi-Prime RSA, encryption is performed in exactly the same was as traditional RSA. For decryption, Multi-Power RSA is able to capitalize on the fact that there are only two distinct prime numbers. So, only two large modular exponentiation computations are necessary (there are several smaller mathematical operations involved using this technique which are computationally negligible), providing increased efficiency over the Multi-Prime method. In Multi-Power RSA, like Multi-Prime and CRT RSA, all of the distinct prime factors of the modulus N are used for decryption of messages.

The result is a theoretical speedup of b³/8, where b is the number of prime factors used. With N of length 1024 bits and b set to 3 (the current maximum for security reasons), Multi-Power RSA achieves a theoretical speedup of 3.375 over two-factor CRT RSA methods.

Batch RSA

Batch RSA is based on the idea that, in certain situations, two or more decryptions can be performed for the time cost of one. In order for this to work, very small public exponents must be used (such as 3 or 5). Further, the system only works if encryption is performed using different public exponents but the same public modulus. Further discussion of this technique is beyond the scope of this paper, but it is another example of a technique to speed up RSA decryption. With N of length 1024, it speeds up decryption by a factor of 2 or 3. However, there are many practical drawbacks to batch RSA techniques.

Rebalanced RSA

In standard RSA, encryption is much faster than decryption. In many applications, it would be desirable to change this behavior. To date, rebalanced RSA simply shifts more of the burden to the encryption process by increasing the size of the public exponent e (which is usually set to 65537), and tries to decrease the size of the private exponents as much as possible without creating security problems. Rebalanced RSA can be used in conjunction with many of the other methods here, such as Multi-Prime or Multi-Power RSA.

Padding

Most modern cryptographic implementations of RSA involve methods of padding or otherwise preprocessing the plaintext message M to prevent potential attacks on RSA such as chosen ciphertext attacks. However, current preprocessing methodologies involve padding or otherwise selecting a value of M that is roughly the size of the public modulus N. These preprocessing methodologies are incompatible with certain optimizations of RSA such as Subset, Superset, and Group RSA, which require that the value of M after all preprocessing must have a bit length that is significantly smaller than the bit length of N.

Given the fact that nearly all secure Internet traffic (SSL) current utilizes public key encryption/decryption, the present invention provides great utility to the market by providing faster decryption with rebalancing and security with padding or preprocessing plaintext messages to prevent potential security attacks within the context of superset RSA, such that encryption efficiencies and cryptographic security are not seriously compromised.

### SUMMARY OF THE INVENTION

The present invention provides methods for improving the computational efficiency and overall capabilities of RSA by using padding and/or preprocessing plaintext messages to prevent potential security attacks within the context of the general class of SUBSET RSA ALGORITHMS, ie. techniques under which the moduli used for decryption are a proper subset of the public modulus used for encryption.

Accordingly, one aspect of the present invention is to provide a public key cryptosystem and methods having a predetermined number of prime factors used for the generation of a modulus N and an exponent e, which may be generated in a variety of ways, wherein a proper subset of the prime factors of the modulus N, along with the exponent e, are required to decrypt messages encrypted using the public exponent e and the public modulus N, N is generated using RSA methods, and encryption occurs using RSA methods, wherein the exponents d and e are generated such that e*d=1 mod (N−1) and gcd(e,d)=1, and further including additional method steps for preprocessing plaintext messages to prevent potential security attacks within the context of superset RSA.

### DETAILED DESCRIPTION OF EMBODIMENTS OF THE PRESENT INVENTION

For the present invention, the term messages is defined and used herein to include information, documents, files, and/or data that are preferably, but not necessarily, in electronic form.

The present invention provides a system for encrypting and/or decrypting messages, preferably electronic messages, including a public key cryptosystem where decryption is performed using less than all of the prime factors of the modulus used for encryption, along with the public exponent e.

One embodiment of the present invention provides a method for encrypting/decrypting messages including the steps of: providing a public key cryptosystem having a predetermined number of prime factors used for the generation of a modulus N and an exponent e; wherein less than all of the prime factors of the modulus N are required to decrypt messages capable of being encrypted using the public exponent e and the public modulus N, where e and N are calculated using RSA methods, and encryption occurs using RSA methods, wherein the exponents d and e are generated such that e*d=1 mod (N−1) and gcd(e,d)=1 and the public exponent e contains approximately the same number of bits as the prime number N.

Another embodiment provides a method for encrypting/decrypting messages including the steps of:

Encrypting a plaintext message M into a ciphertext message C using any method that produces a value equivalent to C=M^{e} mod N, where 0≦M<N_{d}, such that the ciphertext C can be decrypted into the plaintext message M using only e and the prime factors of N_{d}

N being the product of all of the numbers in the set S;

S being a set of at least two prime numbers, p₁ . . . . pₖ, where k is an integer greater than 1;

e preferably being a small prime number, alternatively e being a number that is relatively prime to the product of each distinct prime factor of N minus 1, (N₁−1)* . . . (Nⱼ−1) for distinct prime factors of N 1 to j, where j is the number of distinct prime factors in N;

S_{d} being a proper subset of S;

N_{d} being the product of all of the numbers in the set S_{d}. Preferably, a method for decrypting encrypted messages comprising the steps of:

determining if a derived modulus N_{d} is a squarefree number, meaning that its prime decomposition contains no repeated factors, and if so,

decrypting ciphertext C into message M using any method that produces a value equivalent to M=C^{d} mod N_{d}, where d is generated using the following steps:

Calculating the number Z_{d} as the product of each prime factor of N_{d} minus 1, (N_{d1}−1)* . . . (N_{dj}−1) for prime factors of N_{d} 1 to j, where j is the number of prime factors in N_{d};

generating the exponent d such that the following relationship is satisfied: e*d=1 mod Z_{d}.

In one embodiment, the plaintext message M is restored by directly calculating M=C^{d} mod N_{d}.

In another embodiment, M is restored using the steps of:

calculating separate decryption exponents d_{nd1} . . . d_{ndj} for all prime factors of N_{d} 1 to j, where j is the number of prime factors in N_{d} so that the following relationship is satisfied for each member of N_{d}: e*d_{ndi}=1 mod (N_{di}−1); and performing decryptions of the form Mᵢ=C^{d}^{_{ndi}} mod N_{di} for all prime factors of N_{d} from 1 to j, where j is the number of prime factors in N_{d}, and then using the values of each Mᵢ and N_{di} to reconstruct M. These steps for reconstructing M from each value of Mᵢ and N_{di} are preferably performed using the Chinese Remainder Theorem and/or Garner's algorithm, such as set forth in the references C. Vuillame Efficiency Comparison of Several RSA Variants, which are incorporated herein by reference in their entirety.

Alternatively, a method for decrypting encrypted messages including the steps of: decrypting the ciphertext message C to the plaintext message M by determining if the derived modulus N_{d} is squareful number, meaning that its prime decomposition contains at least one square, and if so;

calculating separate decryption exponents d_{nd1} . . . d_{ndj} for all distinct prime factors of N_{d} 1 to j, where j is the number of distinct prime factors in N_{d} so that the following relationship is satisfied for each distinct member of N_{d}: e*d_{ndi}=1 mod (N_{di}−1); for each distinct prime factor of N_{d}, N_{di}, calculating a value b_{di} as the number of times that N_{di} occurs as a prime factor in N_{d};

calculating Mᵢ for each distinct prime factor of N_{d}, N_{di};

and using all values of Mᵢ, N_{di}, d_{ndi}, and b_{di} to restore the plaintext message M. The method of calculating Mᵢ for each distinct prime factor of N_{d}, N_{di} is preferably performed using Hensel Lifting, such as set forth in the references C. Vuillame Efficiency Comparison of Several RSA Variants, which are incorporated herein by reference in their entirety. The restoration of the plaintext message M from the values of Mᵢ, N_{di}, d_{ndi}, and b_{di} is preferably performed using techniques such as the Chinese Remainder Theorem and/or Garner's algorithm.

Another embodiment of the present invention includes a method for encrypting/decrypting messages, including the steps of:

Encrypting a plaintext message M into a ciphertext message C using any method that produces a value equivalent to C=M^{e} mod Nₚ, where 0≦M<N, such that the ciphertext C can be decrypted into the plaintext message M using e and the prime factors of N

N being the product of all of the numbers in the set S;

S being a set of at least one prime number, p₁ . . . pₖ, where k is an integer greater than 0;

Sₚ being a proper superset of S;

Nₚ being the product of all of the numbers in the set Sₚ;

e preferably being a small prime number, or alternatively, e being a number that is relatively prime to the product of each distinct prime factor of Nₚ minus 1, (Nₚ₁−1)* . . . (Nₚⱼ−1) for distinct prime factors of Nₚ1 to j, where j is the number of distinct prime factors in Nₚ;

Preferably, a method for decrypting encrypted messages including the steps of:

Decrypting the ciphertext message C into the plaintext message M by determining

if the modulus N is a squarefree number; and if so then,

decrypting ciphertext C into message M using any method that produces a value equivalent to M=C^{d} mod N, where d is generated using the following steps:

Calculating the number Z as the product of each prime factor of N minus 1, (N₁−1)* . . . (Nⱼ−1) for prime factors of N 1 to j, where j is the number of prime factors in N;

then generating the decryption exponent d such that the following relationship is satisfied: e*d=1 mod Z;

In one embodiment, M is directly calculated as M=C^{d} mod N In an alternative embodiment, M is calculated including the steps of:

calculating separate decryption exponents d₁ . . . dⱼ for all prime factors of N 1 to j, where j is the number of prime factors in N so that the following relationship is satisfied for each member of N: e*dᵢ=1 mod (Nᵢ−1); and

performing decryptions of the form Mᵢ=C^{d}^{ᵢ} mod Nᵢ for all prime factors of N from 1 to j, where j is the number of prime factors in N. Next, the values of each Mᵢ and Nᵢ are used to reconstruct M, preferably using the Chinese Remainder Theorem and/or Garner's algorithm.

Alternatively, a method for decrypting encrypted messages comprises the steps of:

Decrypting the ciphertext message C to the plaintext message M by determining if the derived modulus N is squareful number; if so then, calculating separate decryption exponents dₙ₁ . . . dₙⱼ for all distinct prime factors of N 1 to j, where j is the number of distinct prime factors in N so that the following relationship is satisfied for each distinct member of N: e*dₙᵢ=1 mod (Nᵢ−1);

for each distinct prime factor of N, Nᵢ, calculating a value bᵢ as the number of times that Nᵢ occurs as a prime factor in N;

Preferably using Hensel Lifting to calculate Mᵢ for each distinct prime factors of N, Nᵢ;

and preferably using the Chinese Remainder Theorem and/or Garner's algorithm to use each value of Mᵢ, Nᵢ, bᵢ and dₙᵢ to restore the plaintext message M;

In still another embodiment of the present invention, encrypting/decrypting messages including the steps of:

Encrypting a plaintext message M into a ciphertext message C using any method that produces a value equivalent to C=M^{e} mod Nₚ, where 0≦M<N, such that the ciphertext C can be decrypted into the plaintext message M using e and the prime factors of N

N being the product of all of the members of set S;

S being a set of at least two numbers, p₁ . . . pₖ where k is an integer greater than 1 and all members of S are equal to pₛ, which is a prime number;

Sₚ being a superset of S;

Nₚ being the product of all of the numbers in the set Sₚ;

e preferably being a small prime number, or alternatively, e being a number that is relatively prime to the product of all of the distinct prime factors of Nₚ minus 1, (Nₚ₁−1)* . . . (Nₚⱼ−1) for distinct prime factors of Nₚ 1 to j, where j is the number of distinct prime factors in Nₚ;

Preferably, decryption of encrypted messages includes the steps of: Decrypting the ciphertext message C to the plaintext message M by:

Calculating b as the number of times that the number pₛ occurs as a prime factor in N;

Generating an exponent d such that the following equation is satisfied:
e*d=1 mod (pₛ−1);

Using Hensel Lifting to transform C into M with d, pₛ, and b as input values.

In still another embodiment of the present invention, a method for crytographic communications is disclosed, including the steps of:

Encrypting a plaintext message M into a ciphertext message C using any method that produces a value equivalent to C=M^{e} mod Nₚ, where 0≦M<p, such that the ciphertext C can be decrypted into the plaintext message M using e and p

p being a prime number;

S being a set containing only the number p;

Sₚ being a superset of S;

Nₚ being the product of all members of the set Sₚ;

e preferably being a small prime number, or alternatively, e being a number that is relatively prime to the product of each distinct prime factor of Nₚ minus 1, (Nₚ₁−1)* . . . (Nₚⱼ−1) for distinct prime factors of Nₚ 1 to j, where j is the number of distinct prime factors in Nₚ;

Preferably, decryption of encrypted messages comprises the steps of: Decrypting using any method that produces a value equivalent to as M=C^{d} mod p, where d is generated using the following step:

Calculating d such that the following equation is satisfied:
e*d=1 mod (p−1);

In another embodiment of the present invention, a method for establishing cryptographic communications is disclosed, including the steps of:

calculating a composite number N, which is formed from the product of distinct prime numbers S, p₁, . . . pₖ where k≧1. Encoding a plaintext message M, to a ciphertext message C, where M corresponds to a number representative of a message and 0≦M<S; generating an exponent e, which is preferably a small prime number but can alternatively be established as any number that is relatively prime to the product of each distinct prime factor of N minus 1, (N₁−1), . . . (Nⱼ−1) for distinct prime factors of N1 to j, where j is the number of distinct prime factors in N; transforming said plaintext, M, into said ciphertext, C, where C is developed using any method that produces a value equivalent to C=M^{e} mod N, such that ciphertext C can be decrypted into plaintext M using only e and S.

Decryption of messages encrypted in such a way is performed by: decoding the ciphertext message C to the plaintext message M, wherein said decoding includes the step of: transforming said ciphertext message C to plaintext M, using any method that produces a value equivalent to M=C^{d} (mod S), where d is generated such that e*d=1 mod (S−1);

Another embodiment of the present invention discloses a system for encrypting and decrypting electronic communications including a network of computers and/or computer-type devices, such as personal data assistants (PDAs), mobile phones and other devices, in particular mobile devices capable of communicating on the network; generating at least one private key and at least one public key, wherein the at least one private key is determined based upon any one of a multiplicity of prime numbers that when multiplied together produce N, which is the modulus for at least one of the public keys.

Another embodiment of the present invention discloses a method for public key decryption where less than all of the distinct prime factors of a number N are used to decrypt a ciphertext message C into plaintext message M, where encryption occurs with the public key {e, N} using any method that produces a value equivalent to C=M^{e} mod N.

Another embodiment of the present invention discloses a method for public key encryption with a public key {e, N} where a plaintext message M is encrypted into a ciphertext message C using any method that produces a value equivalent to C=Me mod (N*X), where N is the public modulus and X is any integer greater than 1.

Another embodiment of the present invention discloses a method for public key decryption of a message that has been encrypted with the public key {e, N} where a ciphertext message C is decrypted into a plaintext message M using any method that produces a value equivalent to M=C^{d} mod N_{d}, where N_{d} is the product of less than all of the prime factors of the public modulus N and d satisfies the equation e*d=1 mod Z, where Z is the product of each of the k prime factors of N_{d} minus 1, (p₁−1)* . . . (pₖ−1).

Yet another embodiment of the present invention discloses a method for public key decryption of a message that has been encrypted using any method that produces a value equivalent to C=M^{e} mod N, where a ciphertext message C is decrypted into a plaintext message M using any method that produces a value equivalent to M=C^{d} mod N_{d}, where N_{d} is the product of less than all of the prime factors of the public modulus N and d satisfies the equation e*d=1 mod Z, where Z is the product of each of the k prime factors of N_{d} minus 1, (p₁−1)* . . . (pₖ−1).

Generally, decryption methods according to the present invention are paired with particular encryption steps such that decryption is accomplished using the encryption exponent e and less than all of the prime factors of the encryption modulus, as set forth in the following design examples, which are provided for the purpose of illustrating methods of the present invention, without limiting it expressly thereto.

### DESIGN EXAMPLES

### Example #1

Generating prime numbers p and q as the members of set S, and calculating N=p*q. It is preferred that p is set to the minimum bit length, given existing security constraints and the expected message size, and that q is set to a bit length such that the bit length of

N reaches its recommended size.

Calculating e as a small prime number, such as 65537.

Including p as the only member of the proper subset, S_{d}.

Setting N_{d}=p.

Calculating the private exponent d such that e*d=1 mod (p−1).

Encrypting plaintext M into ciphertext C as C=M^{e} mod N, where 0≦M<N_{d}.

Decrypting ciphertext C into plaintext M as M=C^{d} mod N_{d}.

### Example #2

Generating prime number p as the only member of set S, and setting N=p. It is preferred that p is set to the minimum bit length given existing security constraints and the expected message size.

Calculating e as a small prime number, such as 65537.

Creating the set Sₚ as a proper superset of set S containing members p and q, and calculating Nₚ=pq. It is preferred that q is large enough so that the bit length of the Nₚ reaches its recommended size.

Calculating the private exponent d such that e*d=1 mod (p−1).

Encrypting plaintext M into ciphertext C as C=M^{e} mod Nₚ, where 0≦M<N.

Decrypting ciphertext C into plaintext M as M=C^{d} mod N.

### Example #3

Generating prime number p and choosing the members of set S as {p,p}, and setting N=p².

It is preferred that p is set to the minimum bit length given existing security constraints and expected message size.

Calculating e as a small prime number, such as 65537.

Creating the set Sₚ as a proper superset of set S containing members {p,p,q}, and calculating Nₚ=p²q. It is preferred that q is large enough so that the bit length of the Nₚ reaches its recommended size.

Calculating the private exponent d such that e*d=1 mod (p−1).

Encrypting plaintext M into ciphertext C as C=M^{e} mod Nₚ, where 0≦M<N.

Decrypting ciphertext C into plaintext M by:

Precomputing the value e_inv_p=e⁻¹ mod p;

Calculating Cₛ=C mod p²;

Calculating M₁=Cₛ^{d-1} mod p;

Calculating K₀=(M₁*Cₛ) mod p;

Calculating A=(C−K₀^{e}) mod p²;

Calculating M₂=(M₁*A) mod p²;

Calculating M₃=(M₂*e_inv_p) mod p²;

Decoding plaintext message M=(M₃+K₀) mod p²;

### Example #4

Generating distinct prime numbers p and q, and choosing the members of set S as {p,q}, and setting N=p*q.

Calculating e as a small prime number, such as 65537.

Creating the set Sₚ as a proper superset of set S containing members {p,q,r}, and calculating Nₚ=pqr, with q chosen so that that N is a squarefree number (all prime factors are distinct).

Calculating the private exponent d such that e*d=1 mod (p−1)(q−1).

Encrypting plaintext M into ciphertext C as C=M^{e} mod Nₚ, where 0≦M<Nₚ.

Decrypting ciphertext C into plaintext M by:

Calculating Mₚ=M mod p;

Calculating M_{q}=M mod p;

Calculating p_inv_q=p⁻¹ mod q;

Calculating V=(M_{q}−Mₚ) mod q;

Calculating V₁=V*p_inv_q mod q;

Calculating M₁=V*p mod N;

Calculating plaintext M=(M₁+Mₚ) mod N;

### Example #5

Being provided a public key {e, N};

Generating a number X as a large prime number;

Encrypting a plaintext message M into a ciphertext message C as: C=M^{e} mod (N*X);

Provided that M<X and M<N, decryption can occur in either of two ways:

M=C^{d} mod N, using the private key that corresponds to the public key {e, N} Or

M=C^{d}^{ₓ} mod X, where dₓ is calculated such that e* dₓ=1 mod (X−1).

As the foregoing provides for methods for providing a cryptographic system of the present invention, the present invention adapts the same and further provides the following methods to use padding and/or preprocessing of plaintext messages to prevent potential security attacks within the context of the general class of SUBSET RSA ALGORITHMS, meaning that the moduli used for decryption are a proper subset of the public modulus used for encryption.

The present invention provides methods for preprocessing plaintext messages to prevent potential security attacks within the context of the general class of SUBSET RSA ALGORIGHTMS. SUBSET RSA methods require that the plaintext message M be shorter in length than the number P, which is used for the calculation of the private exponent d. Also, because of the requirement that M<P, these RSA methods are exposed to some additional potential attacks that traditional RSA is not subject to.

In one implementation according to the present invention, a random integer z between 0 and Y is selected, where Y<P. Next, z is encrypted in the normal way as c=z^{e} mod N_{X}. Next, the integer z is used to create another key KEK. Most often, KEK will be a symmetric key. Then, the plaintext message M is encrypted into integer WK using KEK preferably using a symmetric encryption algorithm. Decryption of M occurs by first decrypting c using the superset RSA algorithm: zₚ=c^{d} mod P. If zₚ>Y, the encrypted text will be rejected. Otherwise, zₚ is used to create the key KEKₚ. Finally, KEKₚ is applied to WK to produce Mₚ. It is preferable that the symmetric key algorithm provide a mechanism for determining with certainty whether Mₚ=M. The algorithm should output an error if Mₚ!=M.

In another implementation according to the present invention, a plaintext message M is chosen where M<=Y<P. M is then transformed into an integer z roughly of length M such that z<=Y<P. In the simple case, M=z. In other cases, it may be desirable to transform M using an XOR or other operation that preserves the bit length of M. Encryption then occurs in the normal way as c=z^{e} mod N_{X}. Additionally, it is required that supplemental verification data v be provided along with the encrypted ciphertext c. Verification data v will allow the decrypting party to determine with certainty whether the decrypted message matches the original plaintext message M. An example of verification data is a simple hash of the plaintext message M. Decryption of M occurs by first decrypting c using SUBSET RSA algorithms: zₚ=c^{d} mod P. If zₚ>Y, the encrypted text will be rejected and the algorithm should output an error. Next, some or all of the verification data may be used to convert zₚ to Mₚ. Finally, the verification data v will be used to confirm that Mₚ=M. If Mₚ!=M, the algorithm should output an error.

Certain modifications and improvements will occur to those skilled in the art upon a reading of the foregoing description. All modifications and improvements have been deleted herein for the sake of conciseness and readability but are properly within the scope of the present invention.

What is claimed is:

1. A public key cryptosystem for secure communication of messages comprising:
at least one message encrypted by standard RSA methods;
a predetermined number of prime factors used for the generation key(s) for decryption including a modulus N and an exponent e, wherein a proper subset of the prime factors of the modulus N, along with the exponent e, are required to decrypt messages encrypted using the public exponent e and the public modulus N, N is generated using RSA methods, and encryption occurs using RSA methods, wherein the exponents d and e are generated such that e*d=1 mod (N−1) and gcd(e,d)=1, and further including additional method steps for preprocessing plaintext messages to prevent potential security attacks within the context of superset RSA; and wherein the system is operable to decrypt encrypted messages using the key(s).

2. A method for providing a public key cryptosystem comprising the steps of:
providing an encrypted message, wherein the encryption occurs using RSA methods;
providing a predetermined number of prime factors;
generating a modulus N and an exponent e using the prime factors, wherein a proper subset of the prime factors of the modulus N, along with the exponent e, are required to decrypt messages encrypted using the public exponent e and the public modulus N, wherein N is generated using RSA methods;
generating exponents d and e such that e*d=1 mod (N−1) and gcd(e,d)=1;
decrypting at least one message using the generated key(s).

3. The method of claim 2, further including the step of preprocessing plaintext messages to prevent potential security attacks within the context of superset RSA.

4. The method of claim 2, further including the steps of:
providing a random integer z between 0 and Y, where Y<P;
encrypting z in the normal way as c=z^{e} mod N_{X};
generating another key KEK;
encrypting a message M into integer WK using KEK.

5. The method of claim 4, wherein KEK is a symmetric key.

6. The method of claim 4, wherein message M is a plaintext message.

7. The method of claim 4, wherein the step of encrypting the message M is performed using a symmetric encryption algorithm.

8. The method of claim 4, further including the step of decrypting the encrypted message M, further including the following steps:
decrypting c using the superset RSA algorithm: zₚ=c^{d} mod P for creating the key KEKₚ, and applying KEKₚ to WK to generate Mₚ.

9. The method of claim 8, wherein if zₚ>Y, the encrypted text is rejected.

10. The method of claim 8, further including the step of providing an error if Mₚ!=M.

11. A method for providing a public key cryptosystem comprising the steps of:
providing a plaintext message M where M<=Y<P;
encrypting the message M, further including the steps of
transforming M into an integer z roughly of length M such that z<=Y<P and then encrypting according to c=z^{e} mod N_{X};
providing supplemental verification data v with an encrypted ciphertext c.

12. The method of claim 11, wherein either M=z or transforming M using an XOR or other operation that preserves a bit length of M.

13. The method of claim 11, wherein the verification data v is operable to allow a decrypting party to determine with certainty whether the decrypted message matches the original plaintext message M.

14. The method of claim 11, wherein decryption of M further includes the following steps:
first decrypting c using SUBSET RSA algorithms: zₚ=c^{d} mod P, such that if zₚ>Y, then encrypted text is rejected and an error is provided;
next, using some or all of the verification data to convert zₚ to Mₚ;
finally, using the verification data v to confirm that Mₚ=M.

15. The method of claim 14, wherein if Mₚ!=M, then another error output is provided.
